(19) United States
(12) Patent Application Publication
(10) Pub. No.: US 2019/0094879 A1
(43) Pub. Date: Mar. 28, 2019

(54) DRIVING SYSTEM, TRANSPORTATION MEANS CONTROLLED BY DRIVING SYSTEM, AND METHOD FOR CONTROLLING TRANSPORTATION MEANS USING DRIVING SYSTEM

(71) Applicant: Song Tok Choe, Seoul (KR)

(72) Inventor: Song Tok Choe, Seoul (KR)

(21) Appl. No.: 16/141,102

(22) Filed: Sep. 25, 2018

(30) Foreign Application Priority Data
Sep. 26, 2017 (KR) 10-2017-0124457

(51) Int. Cl. G05D 1/02; E01C 9/00; H01F 7/06

(52) U.S. Cl. CPC G05D 1/0259; E01C 9/00; H01F 7/02; G05D 2201/0213; H01F 7/064

(57) ABSTRACT

The present invention relates to a driving system for moving a transportation means including a rotating means made of a magnetic body by changing a magnetic field distribution on a road, a transportation means controlled by the driving system, and method for controlling the transportation means by the driving system.

In one embodiment of the invention, the driving system for moving transportation means comprising a plurality of rotating members made of a magnetic body which reacts to a magnetic field and a body supported by the rotating member is provided. The driving system comprises a road portion comprising plurality of areas divided on a surface. Each of the plurality of areas has magnetic control means disposed therein to alter the magnetic forces affecting exterior. The driving system includes a controller for controlling the magnetic control means to control the magnetic field applied to the exterior of each of the plurality of areas. The controller is configured to dynamically control the magnetic control means so that the transportation means can be moved on the road portion.

### TECHNICAL FIELD

The present invention relates to a driving system, a transportation means controlled by the driving system, and method for controlling the transportation means by the driving system. More particularly, it relates to a driving system for moving a transportation means that includes a rotating means made of a magnetic body by changing magnetic field distribution on a road, and transportation means controlled by the driving system, and method for controlling the transportation means by the driving system.

### DESCRIPTION OF THE RELATED ART

A transportation means such as an automobile moves on a desired route and speed selected by a driver who directly operates a steering wheel and adjusts the speed. Accordingly, controlling the transportation means becomes difficult and results in an accident when carelessness of the driver, an unexpected situation on the road, or the like occurs.

An autonomous driving system has been developed in order to reduce such traffic accidents and to enhance convenience of the driver (refer to Patent Document 1). The autonomous driving system is a system that allows the transportation means to drive by itself without requiring the driver to operate the transportation means directly.

Conventional autonomous driving system determines driving strategy based on information of driving environment collected from various sensors such as a GPS, radar or camera. Based on such driving strategy, a driving route is created, thereby moving the transportation means to the desired route by controlling the speed and steering of the transportation means.

However, there is a limitation for such a conventional autonomous driving system to travel safely to a desired driving route when structure of an existing automobile is used. Therefore, there are needs for a new transportation means and a new driving system that can operate the transportation means as desired from outside.

Korea Patent Publication No. 10-2013-0091907 (entitled “APPARATUS AND METHOD FOR AUTONOMOUS DRIVING”)

### BRIEF SUMMARY

The present invention has been invented in accordance with the needs as described above. An object of the present invention is to provide a driving system for moving a transportation means including a rotating means made of a magnetic body by changing magnetic field distribution on a road and a transportation means controlled by the driving system, and method for controlling the transportation means by the driving system.

The present invention should not be as limited as mentioned and even if not mentioned other structures and methods will become apparent to a person skilled in the field from the following descriptions.

In order to solve the mentioned problems, one embodiment of a driving system for moving a transportation means comprising a plurality of rotating members made of a magnetic body which reacts to magnetic fields and a body supported by the rotating members, is provided. The driving system comprises a road portion divided by a plurality of areas on a surface, wherein each of the plurality of areas has magnetic control means disposed therein to alter magnetic forces affecting exterior of the plurality of areas; and a controller for controlling the magnetic control means to control the magnetic fields applied to the exterior of each of the plurality of areas. The controller is configured to dynamically control the magnetic force control means so that the transportation means can be moved on the road portion by an attractive force or a repulsive force between the magnetic force control means and the rotating members.

In the other aspect of the present invention, the magnetic force control means is an electromagnet.

In the another aspect of the present invention, a unit cell is disposed inside each of the plurality of areas, and the magnetic force control means is disposed in the unit cell, and the unit cell is configured to be replaceable.

In another aspect of the present invention, the controller is further configured to independently control the intensity of magnetic forces formed on the plurality of areas to control distribution of magnetic forces on the road portion.

In order to solve the as mentioned problems, one embodiment of a transportation means configured to be controlled by a driving system is provided The driving system comprises a road portion divided by a plurality of areas on a surface. Each of the plurality of areas has magnetic control means disposed therein to alter magnetic forces affecting exterior of the plurality of areas. The system also includes a controller for controlling the magnetic control means to control magnetic field applied to exterior of each of the plurality of areas. The transportation means comprises a plurality of rotating members made of a magnetic body which reacts to the magnetic fields, and a body supported by the rotating members, and wherein the transportation means is configured to be moved by an attractive force or a repulsive force between the magnetic force control means and the rotating members.

In the other aspect of the present invention, the rotating member has a shape of a sphere, and outside of the rotating member forms a N pole or a S pole.

In another aspect of the present invention, a facing portion facing the rotating member is provided inside the body. The facing portion has the same pole as the N pole or the S pole such that the body floats against the rotating member.

In another aspect of the present invention, the rotating member has a shape of a sphere, and is made of ferromagnetic.

In order to solve the as mentioned problems, one embodiment of A method for controlling movement of a transportation means comprising a plurality of rotating members made of a magnetic body which reacts to magnetic fields and a body supported by the rotating members is provided. The driving system comprises a road portion divided by a plurality of areas on a surface. Each of the plurality of areas has magnetic control means disposed therein to alter magnetic forces affecting exterior of the plurality of areas. The driving system includes a controller for controlling the magnetic control means to control magnetic fields applied to the exterior of each of the plurality of areas. The method comprises receiving information on the movement of the transportation means by the controller and controlling the magnetic force control means in at least one area on a moving direction or adjacent areas according to the information on the movement with reference to the rotating member thereby attracting the rotating members to the magnetic force control means.

In the other aspect of the present invention, the method further comprises controlling the magnetic force control means in at least one area on the opposite direction of the moving direction or the adjacent areas according to the information on the movement with reference to the rotating member thereby repulsing the rotating members from the magnetic force control means.

In the other aspect of the present invention, the controller receives the information on the movement of the transportation means from the transportation means.

In another aspect of the present invention, the controller receives the information on the movement of the transportation means from an external user terminal such that the transportation means can autonomously navigate.

According to the driving system, the transportation means controlled by the driving system, and the method for controlling the transportation means by the driving system, the transportation means can be easily controlled with desired properties and it is possible to implement an efficient autonomous navigation.

### DESCRIPTION OF DRAWINGS

FIG. 1 is a view schematically showing a configuration of a driving system according to an embodiment of the present invention.

FIG. 2 is a schematic side view of a transportation means according to an embodiment of the present invention.

FIG. 3 is a schematic bottom view illustrating the structure of various rotating means of the transportation means of FIG. 2.

FIG. 4 is a schematic cross-sectional view illustrating the configuration between a body and the rotating means of the transportation means of FIG. 2.

FIG. 5 is a flowchart of a method of controlling the driving system for moving the transportation means.

FIG. 6 and FIG. 7 are views for describing a method of moving the transportation means on the road portion.

FIG. 8 is a view for explaining a method of decelerating the transportation means on the road portion

FIG. 9 illustrates the movement of the transportation means by means of the control of each rotating member.

### DETAILED DESCRIPTION

The advantages and features of the present invention and the manner of achieving them will become apparent with reference to the embodiments described in detail below with reference to the accompanying drawings. The present invention may, however, be embodied in many different forms and should not be construed as being limited to the embodiments set forth herein rather, these embodiments are provided so that this disclosure will fully convey the scope of the invention to those skilled in the art. The present invention is only defined by the scope of the claims.

Although the first, second, etc. are used to describe various components, these components are not limited by these terms. These terms are only used to distinguish one component from another. Thus, the first component mentioned below may be the second component within the technical spirit of the present invention.

In the accompanying drawings in which like reference numerals may be used to refer similar elements having the same function in different drawings.

The sizes and thicknesses of the individual components shown in the drawings are shown for convenience of explanation and the present invention is not necessarily limited to the size and thickness of the components shown in the drawings.

A driving system of the present invention, a transportation means controlled by the driving system, and a method for controlling the transportation means by the driving system will be described with reference to the accompanying drawings.

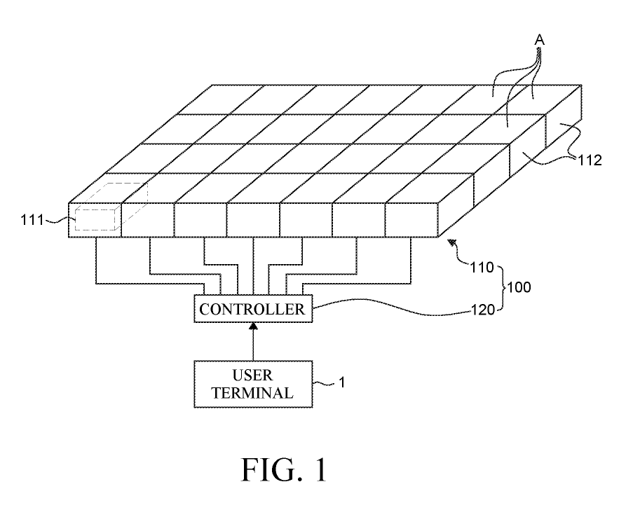

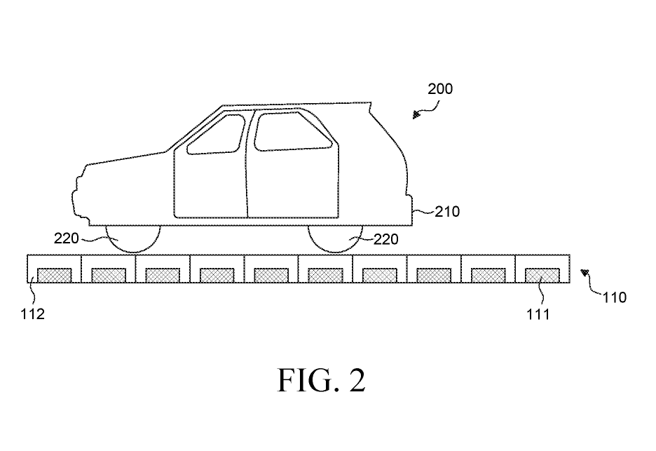

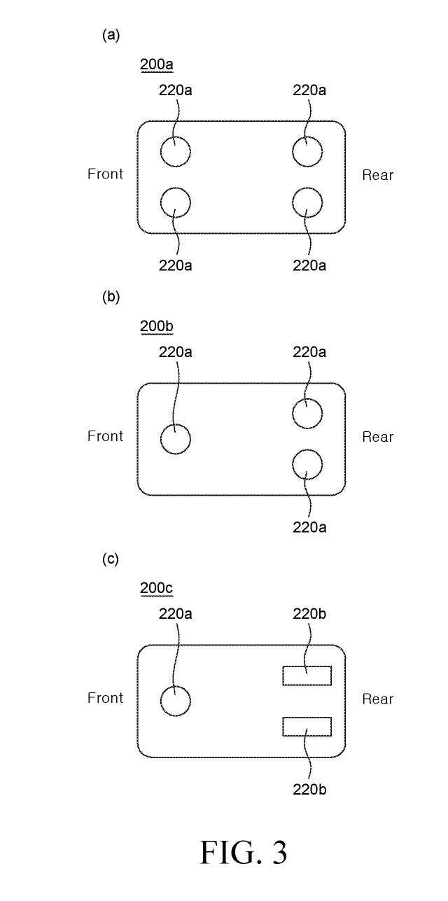

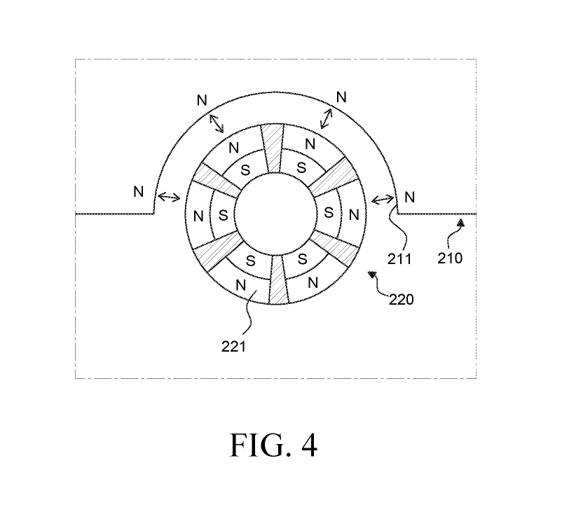

FIG. 1 is a view schematically showing a configuration of a driving system according to an embodiment of the present invention. FIG. 2 is a schematic side view of a transportation means according to an embodiment of the present invention. FIG. 3 is a schematic bottom view illustrating the structure of various rotating means of the transportation means of FIG. 2. FIG. 4 is a schematic cross-sectional view illustrating the configuration between a body and the rotating means of the transportation means of FIG. 2.

Referring to FIGS. 1 to 4, a configuration of a driving system and a transportation means controlled by the driving system according to an embodiment of the present invention will be described.

Referring to FIG. 1, a driving system 100 according to an embodiment of the present invention includes a road portion 110 and a controller 120.

The road portion 110 is divided by a plurality of areas A on the surface. Inside each of the plurality of areas (A), a magnetic control means 111 for changing a magnetic force affecting exterior is provided. In other words, each of a plurality of areas A can be controlled to form a magnetic field of N pole, a magnetic field of S pole, or form no magnetic field. More specifically, the road portion 110 is configured to freely control the distribution of the magnetic field on the surface of the road portion 110.

On the other hand, it is desirable that unit cells 112 are disposed inside each of the plurality of areas A, the magnetic control unit 111 is disposed in the unit cells 112, and the unit cells 112 are configured to be replaceable. It is advantageous in terms of mass production and maintenance when the road portion 110 is constructed with replaceable unit cell 112.

Although the plurality of areas A are exemplified in a square shape divided on the surface of the road portion 110 in this embodiment, the present invention is not limited thereto and may have other shapes such as a rectangular shape and a triangular shape.

Further, in this embodiment, the total of the plurality of areas A is exemplified as constituting the surface of the road portion 110, but does not exclude the existence of an area other than a plurality of areas A that do not form a magnetic field.

The magnetic control means 111 is collectively referred to as means capable of generating magnetic force outside. For example, the magnetic control means 111 may be an electromagnet. However, the present invention is not limited thereto, and any means capable of controlling a state forming magnetic fields and a state not forming the magnetic fields may be employed as the magnetic control means. For example, magnetic control devices such as described in Korean Patent Registration No. 10-1498864 (entitled “MAGNETIC SUBSTANCE HOLDING DEVICE”) and Korean Patent Application No. 10-2016-0028415 (entitled “MAGNETIC FLUX CONTROL DEVICE”) may be employed as a magnetic control means.

The magnetic control means 111 may form magnetic fields of N pole, or magnetic fields of S pole, or form no magnetic field on the areas A. It is determined which pole are formed depending the configurations of the transportation means described below.

The magnetic control means 111 can freely adjust intensity of the magnetic fields formed therefrom. When the magnetic control means 111 is an electromagnet, the intensity of the magnetic field can be adjusted by adjusting intensity of electric currents supplied to the electromagnet.

Although only one magnetic control means 111 is illustrated in FIG. 1, it should be understood that the magnetic control means 111 are located in all of the unit cells 112.

Further, the unit cells 112 are preferably shielded from each other to avoid magnetic interference with each other. The magnetic interference generated between unit cells 112 may inhibit forming of the magnetic fields on the road portion 110.

The controller 120 controls the magnetic fields affecting exterior of each of the plurality of areas A formed on the road portion 110 by controlling the magnetic control means 111.

When the magnetic control means 111 are made of the electromagnet, the controller 120 can adjust the magnetic fields affecting exterior of the areas A by controlling a direction and intensity of currents applied to the electromagnet.

Specifically, the controller 120 dynamically controls the magnetic control means 111 such that the transportation means 200 may move on the road portion 110. That is, the controller 120 can control the magnetic control means 111 such that the magnetic body on the road portion 110 may be moved by generating magnetic fields in a specific one of the plurality of areas A.

On the other hand, the controller 120 may be connected to a user terminal 1. At this time, the user terminal 1 may be one of electronic devices such as a desk-top, a tablet, a smart phone, a PC, etc.

The controller 120 receives information on route and information on transportation from the user terminal 1 by wired/wireless communication, and based on the information, controls the magnetic control means 111 of the road portion 110 for moving the transportation means 200 to desired place.

On the other hand, the controller 120 may be configured to independently control the intensity of the magnetic forces formed on the plurality of areas A to form magnetic force distribution on the road portion 110. For example, the controller 120 controls the magnetic control means 111 of the road portion 110 to generate the largest magnetic force in any one of the areas and to form distribution of decreasing intensities of the magnetic forces as away from the one of the areas.

Referring to FIGS. 2 to 4, configuration of a transportation means 200 moved by the driving system 100 described above will be described in detail.

First, Referring to FIGS. 2 to 4, the transportation means 200 in accordance with one embodiment of the present invention includes a body 210 and at least one rotating member 220.

The body 210 has a space for receiving a person or a load, and is supported by a rotating member 220, which will be described later. Although the body 210 is shown in the form of an automobile in the present embodiment, this is merely an example.

The rotating member 220 is made of a magnetic body which reacts to magnetic fields and contacts the road portion 110. The rotating member 220 is made of ferromagnetic such as iron, and formed to have a N pole or a S pole outside.

For example, referring to FIG. 4 in particular, the rotating member 220 may be configured by disposing a plurality of permanent magnets 221 such that the N pole faces outer circumferential surface and the S pole faces inward. In this case, outside of the rotating member 220 has a N-pole. Of course, arrangement of the permanent magnet 221 can be reversed, such that the rotating member 220 has the S pole outside.

As such, when the rotating member 220 is made of a ferromagnetic material such as iron or has the N pole or the S pole outside, magnetic fields may be applied to a part of the plurality of areas A of the road portion 110 to move the rotating member 220 so that the transportation means 200 can be moved.

Meanwhile, the rotating member 220 is preferably in a form of a sphere. If it has a form of a sphere, it makes free to steer forward and backward as well as left and right.

While the body 210 may rest on the rotating member 220 and may be fixed in a sliding with each other, as shown in FIG. 4 it is preferable to form a facing portion on an inner surface of the body 210 and making it to face the rotating member 220, allowing to have same polarity of an outer surface of the rotating member 220 thereby making the body 210 to float against the rotating member 220 by repulsive forces.

Specifically, by disposing the N pole of the permanent magnet on the outside of the facing portion 211, the body 210 can be floated against the rotating member 220 not contacting each other. Of course, nonmagnetic elastic bodies such as rubber, which do not affect the magnetic field, may be disposed on the facing portion 211 in order to absorb the unintended impact between the facing portion 211 and the rotating member 220. It is also possible to apply the lubricant to the facing part 211 to minimize impacts.

Referring to FIG. 3, the rotating member 220 may be arranged variously.

As shown in FIG. 3 (a), the transportation means 200a may have four spherical rotating members 220a, as shown in FIG. 3 (b), the transportation means 200b may have three spherical rotating members 220a, and as shown in FIG. 3 (c), the transportation means 200c may have one spherical rotating member 220a and two wheel-shaped rotating members 220b. As such, shapes and arrangements of the rotating members 220a and 220b can be variously set.

Meanwhile, all of the rotating members 220a and 220b shown in FIG. 3 may be made of a magnetic material, or some of them may be formed of a magnetic material and the others may be formed of a non-magnetic material. For example, in FIG. 3 (a), the two rotating members located at the front may be made of a magnetic material, in FIG. 3 (b), one of the rotating member located at the front may be made of a magnetic material, and in FIG. 3 (c), one of the rotating member located at the front may be made of a magnetic material. However, in order to freely control the movement of the transportation means 200 forward and backward, it is preferable that all of the rotating members are made of a magnetic material.

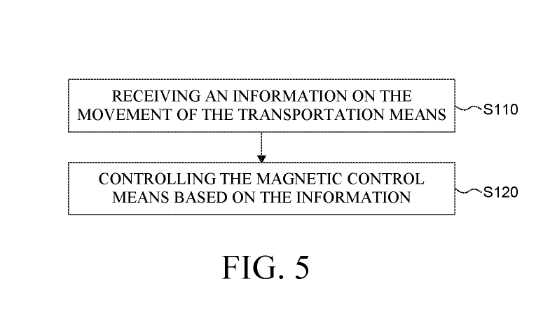

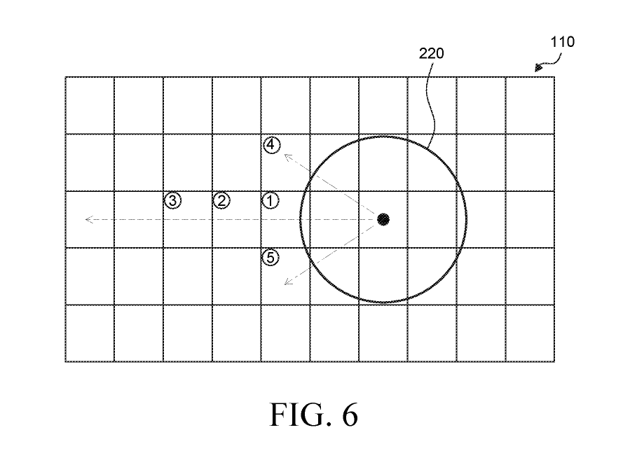

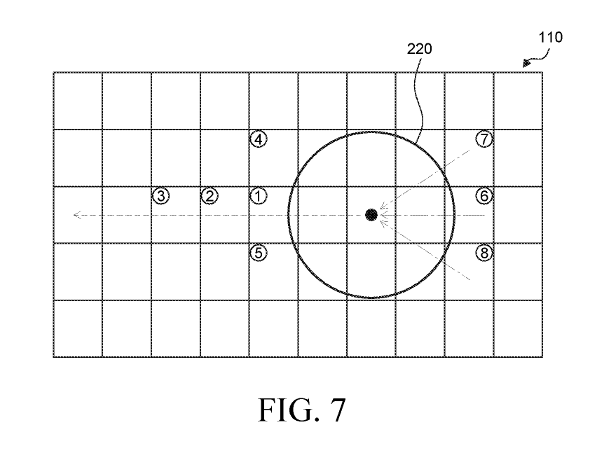

FIG. 5 is a flowchart of a method of controlling the driving system for moving the transportation means, and FIG. 6 and FIG. 7 are views for describing a method of moving the transportation means on the road portion.

Referring to FIG. 5, a method of controlling the driving system for moving a transportation means will be described.

First, the controller 120 of the driving system 100 receives information on movement of the transportation means 110 from outside (S110). The information on the movement includes information on a route of moving, moving speed, and the like. Also, the outside includes a user terminal or other devices. For example, the driving system 100 may receive information on the movement from the transportation means 110 and information on the movement from the user terminal 1 other than the transportation means 110. That is, the transportation means 110 may be moved according to an intention of a driver boarded in the vehicle, or may be autonomously navigated along a route set by the user terminal 1.

Then, based on the information on the movement, the controller 120 controls the magnetic control means 111 in at least one area on a moving direction or adjacent areas according to the information on the movement with reference to the rotating member such that the magnetic control means 111 is allowed to attract the rotating member 220 (S120).

This step (S120) will be described in detail with reference to FIG. 6 and FIG. 7.

FIG. 6 shows what is seen from above the road portion 110, and the rotating member 220 is depicted as a circle. As movement of the rotating member 220 is defined, movement of the transportation means 200 can also be defined accordingly.

A direction in which the rotating member 220 is intended to move is shown by a dotted arrow. In order for the rotating member 220 to move in a direction in which the rotating member 220 is intended, the magnetic control means 111 of the areas occupying the route to be moved is sequentially controlled to form magnetic fields attracting the rotating member 220. That is, the rotating member 220 can be moved in a direction intended by sequentially controlling the areas of \textcircled{1}, \textcircled{2}, and \textcircled{3}.

On the other hand, it is also possible to control a plurality of the magnetic control means 111 so that the direction of the force applied to the rotating member 220 is various and a resultant force is formed in the direction to move.

For example, if magnetic fields of the same magnitude are applied to the areas of \textcircled{4} and \textcircled{5}, attraction force (dot-and-dash line) acts in the directions of \textcircled{4} and \textcircled{5} respectively, so that the resultant forces are formed in the direction to move (dotted arrow direction). That is, it is possible to generate a desired movement of the rotating member 220 using the magnetic fields of peripheral areas as well as the areas located in the direction to be moved.

Meanwhile, in the present embodiment, the rotating member 220 can be moved by controlling the magnetic fields of three adjacent areas. However, the present invention is not limited thereto, and as the resultant forces form distribution of magnetic fields of any form in a desired movement direction thereby moving the rotating member 220 also falls within the scope of the present invention.

On the other hand, referring to FIG. 7, unlike FIG. 6, a force may be applied to the rotating member 220 by using a repulsive force rather than an attraction force. For example, if the rotating member 220 is formed as shown in FIG. 4, an N pole may be applied to a backward direction.

Specifically, when the N pole is formed in an area \textcircled{6} immediately after the route (shown by a dotted line) to be moved, the rotating member 220 receives a force in a direction to move. In addition, similar to described above, even if the N pole is formed in the areas \textcircled{7} and \textcircled{8}, the rotating member 220 receives the force in the direction to move by the resultant force.

However, the repulsive force cannot guarantee movement of the transportation means 200 in a correct direction. Therefore, basically, it is preferable that the transportation means 200 is controlled by control of the attraction force as shown in FIG. 6, and when acceleration of the transportation means 200 is required, or more force is required, it is more preferable to utilize the control as shown in FIG. 7.

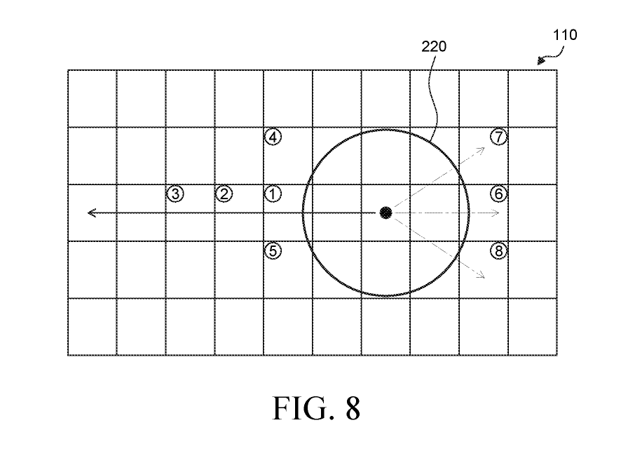

FIG. 8 is a view for explaining a method of decelerating the transportation means on the road portion.

Referring to FIG. 8, a method of decreasing the speed during the moving of the rotating member 220 in the direction of solid arrow will be described.

In order to decelerate, a reaction force in an opposite direction to a moving direction may be applied to the rotating member 220. To apply the reaction force, the magnetic control means in the area \textcircled{6} is controlled to attract the rotating member 220 in the area \textcircled{6}. For example, if a surface of the rotating member 220 has N-pole, deceleration is achieved by controlling the magnetic control means so that the S-pole is applied to the area \textcircled{6}. Also, deceleration may be performed by forming the S pole in the areas \textcircled{7} and \textcircled{8} and forming the resultant force in a direction opposite to the moving direction.

On the other hand, it is preferable to remove the application of the magnetic fields to the areas \textcircled{1}, \textcircled{2}, \textcircled{3}, \textcircled{4}, and \textcircled{5} existing in the moving direction of the rotating member 220 for the deceleration. For the rapid deceleration, the magnetic field control means in the areas \textcircled{1}, \textcircled{2}, \textcircled{3}, \textcircled{4}, and \textcircled{5} may be controlled so that repulsive force acts between the areas \textcircled{1}, \textcircled{2}, \textcircled{3}, \textcircled{4}, \textcircled{5} and the rotating member 220.

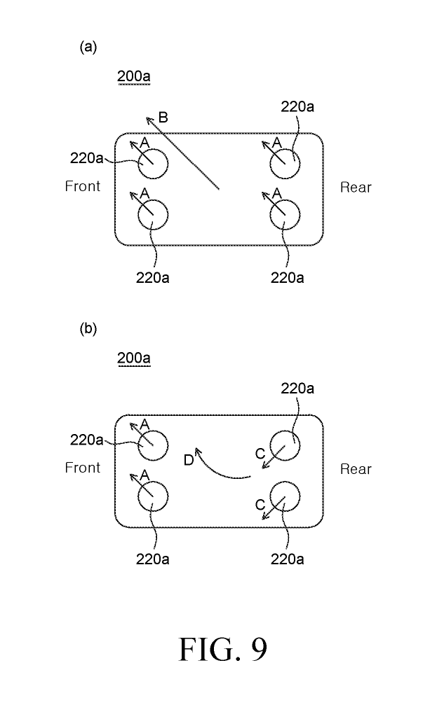

FIG. 9 illustrates the movement of the transportation means by means of the control of each rotating member.

Referring to FIG. 9, the movement of the transportation means 200a is controlled depending on a direction of a force applied to each rotating member 220a.

As shown in FIG. 9 (a), when all of the four rotating members 220a are controlled to receive a force in a direction of arrow A by the driving system 100, each of the rotating members 220a is moved in parallel to the direction of arrow A so that the transportation means 200a are moved in parallel in the direction of an arrow B due to the resultant force.

As shown in FIG. 9 (b), when the driving system 100 controls two of the driving members 220a disposed at the front receiving a force in the direction of arrow A and two of the rotating members 220a disposed at the rear receiving a force in the direction of arrow C, the transportation means 200 will advance rotating clockwise as in D, due to its resultant force.

That is, by the resultant force applied to each routing member 220a, transportation means 200a may be deflected in parallel as shown in FIG. 9 (a) and may be deflected as it rotates as shown in FIG. 9 (b). Such various movements of the transportation means 200 can be variously controlled depending on how to control the respective rotating members 220, and any modification will belong to the scope of the present patent.

While the present invention has been described in connection with accompanying drawings, it will be understood by those skilled in the art that the present invention may be embodied in other specific forms without departing from the spirit or essential characteristics thereof. Thus the embodiments described above are only to be understood as illustrative and non-limited in every respect.

1. A driving system for moving transportation means comprising a plurality of rotating members made of a magnetic body which reacts to magnetic fields and a body supported by the rotating members, comprising
a road portion divided by a plurality of areas on a surface, wherein each of the plurality of areas has magnetic control means disposed therein to alter magnetic forces affecting exterior of the plurality of areas; and
a controller for controlling the magnetic control means to control the magnetic fields applied to the exterior of each of the plurality of areas,
wherein the controller is configured to dynamically control the magnetic force control means so that the transportation means can be moved on the road portion by an attractive force or a repulsive force between the magnetic force control means and the rotating members.

2. The driving system of claim 1, wherein the magnetic force control means is an electromagnet.

3. The driving system of claim 1, wherein a unit cell is disposed inside each of the plurality of areas, and the magnetic force control means is disposed in the unit cell, and the unit cell is configured to be replaceable.

4. The driving system of claim 1, wherein the controller is further configured to independently control the intensity of magnetic forces formed on the plurality of areas to control distribution of magnetic forces on the road portion.

5. A transportation means configured to be controlled by a driving system, wherein the driving system comprising a road portion divided by a plurality of areas on a surface, wherein each of the plurality of areas has magnetic control means disposed therein to alter magnetic forces affecting exterior of the plurality of areas; and a controller for controlling the magnetic control means to control magnetic field applied to exterior of each of the plurality of areas, comprising,
a plurality of rotating members made of a magnetic body which reacts to the magnetic fields; and
a body supported by the rotating members, and
wherein the transportation means is configured to be moved by an attractive force or a repulsive force between the magnetic force control means and the rotating members.

6. The transportation means of claim 5, wherein the rotating member has a shape of a sphere, and outside of the rotating member forms a N pole or a S pole.

7. The transportation means of claim 6, wherein a facing portion facing the rotating member is provided inside the body, the facing portion having the same pole as the N pole or the S pole such that the body floats against the rotating member.

8. The transportation means of claim 5, wherein the rotating member has a shape of a sphere, and is made of ferromagnetic.

9. A method for controlling movement of a transportation means comprising a plurality of rotating members made of a magnetic body which reacts to magnetic fields and a body supported by the rotating members by a driving system wherein the driving system comprising a road portion divided by a plurality of areas on a surface, wherein each of the plurality of areas has magnetic control means disposed therein to alter magnetic forces affecting exterior of the plurality of areas; and a controller for controlling the magnetic control means to control magnetic fields applied to the exterior of each of the plurality of areas, comprising,
receiving information on the movement of the transportation means by the controller; and
controlling the magnetic force control means in at least one area on a moving direction or adjacent areas according to the information on the movement with reference to the rotating member thereby attracting the rotating members to the magnetic force control means.

10. The method of claim 9, further comprising controlling the magnetic force control means in at least one area on the opposite direction of the moving direction or the adjacent areas according to the information on the movement with reference to the rotating member thereby repulsing the rotating members from the magnetic force control means.

11. The method of claim 9, wherein the controller receives the information on the movement of the transportation means from the transportation means.

12. The method of claim 9, wherein the controller receives the information on the movement of the transportation means from an external user terminal such that the transportation means can autonomously navigate.
